(19) United States
(12) Patent Application Publication
(10) Pub. No.: US 2016/0041019 A1
(43) Pub. Date: Feb. 11, 2016

(54) FLUID CONTROL SYSTEM

(71) Applicant: Marwan Hannon, San Francisco, CA (US)

(72) Inventor: Marwan Hannon, San Francisco, CA (US)

(21) Appl. No.: 14/453,027

(22) Filed: Aug. 6, 2014

(51) Int. Cl. G01F 15/06

(52) U.S. Cl. CPC G01F 15/063

(57) ABSTRACT

A fluid-flow detection system comprises a flow sensor configured to measure a flow rate of a fluid within a conduit, an energy harvester coupled to the flow sensor, and a wireless communications module coupled to the energy harvester such that the energy harvester is configured to generate electrical energy derived from the fluid flow, the wireless communications module is configured to transmit a wireless signal associated with the measured flow rate, and the wireless communications module transmits the wireless signal when energized by the energy harvester.

### BACKGROUND

Many parts of this country, even of the world, experience occasional droughts which call for voluntary cutbacks of water usage or when the drought is serious, rationing of water. In normally arid regions, such as the western United States, water conservation is a fact of life, even in years with average rainfall amounts. Water districts and utilities may make periodic public service announcements reminding people not to waste water. Others distribute water conservation kits including shower flow restrictors, new fixture seals, and toilet reservoir displacement devices. Moreover, preventing wasteful water flow in large facilities having a large number of water fixtures such as apartments, condominiums, and office buildings has dramatic environmental and economic benefits. However, in many areas water conservation is practiced inconsistently and unevenly.

Additionally, new real estate development opportunities, in particular those in the western United States, are increasingly limited by water availability. Existing or anticipated water shortfalls have caused regulators to restrict or in extreme circumstances, prohibit housing development. For instance, it is understood that California currently requires water agencies to withhold approval for developments until it is determined that sufficient water resources exist to serve a new development for around 20 years.

Also, there are problems associated with water damage caused by undetected leaks. Each year buildings and residences across the globe suffer from water damage caused by leaky appliances, broken pipes and other occurrences where a building owner is not aware that damage has occurred or is ongoing. Water damage and hazards, such as mold for example, are extremely costly to remediate and can result in permanent damage to the value of a structure.

It has been found that while increased water conservation awareness of residents is somewhat helpful, its overall impact is generally recognized as limited. Quite frequently residents or building owners are aware of minor leaks in water fixtures, however the leaks are deemed to be of little significance and therefore go unremedied or unreported. Moreover, the ability to identify leaking water fixtures by individuals can be difficult as these leaks are often very subtle or are obscured inside water storage tanks, such as a toilet tank.

In most instances the detection of faulty water fixtures requires periodic, building-wide water fixture inspections by a trained professional. This can be a major demand on available maintenance resources and results in inspections being performed only on an annual or semi-annual basis. Consequently, timely and cost-effective detection leaking water fixtures has not been achieved. Thus, there is a need, there continues to exist a need for a low-cost, highly-sensitive system and method for quickly and accurately identifying and reporting leaking water fixtures in facilities.

### SUMMARY

As disclosed herein, a fluid-flow detection system comprises a flow sensor configured to measure a flow rate of a fluid within a conduit, an energy harvester coupled to the flow sensor, the energy harvester configured to generate electrical energy derived from the fluid flow, and a wireless communications module coupled to the energy harvester. The wireless communications module is configured to transmit a wireless signal associated with the measured flow rate and the wireless communications module is configured to transmit the wireless signal when energized by the energy harvester.

Also as disclosed herein, a fluid-flow detection system comprises a monitoring and control system. The monitoring and control system is configured to receive a wireless signal associated with a flow rate through a conduit, to calculate a volume of fluid from the wireless signal based on the flow rate through the conduit; and to compare the calculated volume to a predetermined volume. Further, when the calculated volume is less than the predetermined volume, the monitoring and control system is configured to record the calculated volume and to determine a control number. The control number is a number of times that the calculated volume is less than the predetermined volume. Further, when the control number is greater than a predetermined alarm condition, the monitoring and control system is configured to enter into an alarm state.

Further disclosed herein, a method for determining fluid volume in a system comprises measuring, by a flow sensor, a flow rate of a fluid within a conduit, generating, by an energy harvester, electrical energy derived from the fluid flow, energizing, by the energy harvester, a wireless communications module the electrical energy derived from the fluid flow, and transmitting, by a wireless communications module, a wireless signal associated with the measured flow rate when energized. The wireless communications module is configured to transmit the wireless signal when energized by the energy harvester.

Additionally, as disclosed herein, a method for determining fluid volume in a system comprises monitoring, by a flow sensor, an in-rush fluid current through a conduit, generating electricity, by an energy harvester, by harnessing a force of the in-rush fluid current to activate a wireless communications device so that the wireless communications device is able to transmit data, determining, by a processor, a volume of fluid described by the information regarding the in-rush fluid current, comparing, by the processor, the volume of fluid described by the information regarding the in-rush fluid current to a predetermined volume, and determining, by the processor, when the volume of fluid is less than a predetermined portion of the predetermined volume. Further, upon determining, by the processor, that the volume of fluid is less than the predetermined portion, recording the information regarding the in-rush fluid current, calculating, by the processor, a control number that defined as a number of times that the volume of fluid is less than the predetermined portion, determining, by the processor, when the control number is greater than a predetermined alarm condition, and upon determining, by the processor, that the control number is greater than the predetermined alarm condition, entering an alarm state.

### DESCRIPTION OF THE FIGURES

The novel features of the various embodiments are set forth with particularity in the appended claims. The various embodiments, however, both as to organization and methods of operation, together with the advantages thereof, may be understood by reference to the following description taken in conjunction with the accompanying drawings as follows.

FIG. 1 is a diagram of one embodiment of a fluid control system.

FIG. 2 is a diagram of the fluid-flow measuring sensor of the fluid detection unit shown in FIG. 1.

FIG. 3 is a diagram of the power source of the fluid detection unit shown in FIG. 1.

FIG. 4 is a diagram of the wireless communications module of the fluid detection unit shown in FIG. 1.

FIG. 5 is a diagram of the monitoring and control system shown in FIG. 1.

FIG. 6 is a cross-sectional view of an embodiment of a fluid detection unit as described herein.

FIG. 7 is a cross-sectional view of another embodiment of a fluid detection unit as described herein.

FIG. 8 is a logic diagram illustrating of one embodiment of a method for determining fluid volume in a system as described herein.

FIG. 9 is a logic diagram illustrating of another embodiment of a method for determining fluid volume in a system as described herein.

FIG. 10 depicts example network architecture and computing environment for various embodiments of the present disclosure.

FIG. 11 depicts an example computer system in which embodiments of the present disclosure may be implemented.

### DETAILED DESCRIPTION

Various embodiments are described to provide an overall understanding of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting embodiments and that the scope of the various embodiments is defined solely by the claims. The features illustrated or described in connection with one embodiment may be combined, in whole or in part, with the features of other embodiments. Such modifications and variations are intended to be included within the scope of the claims.

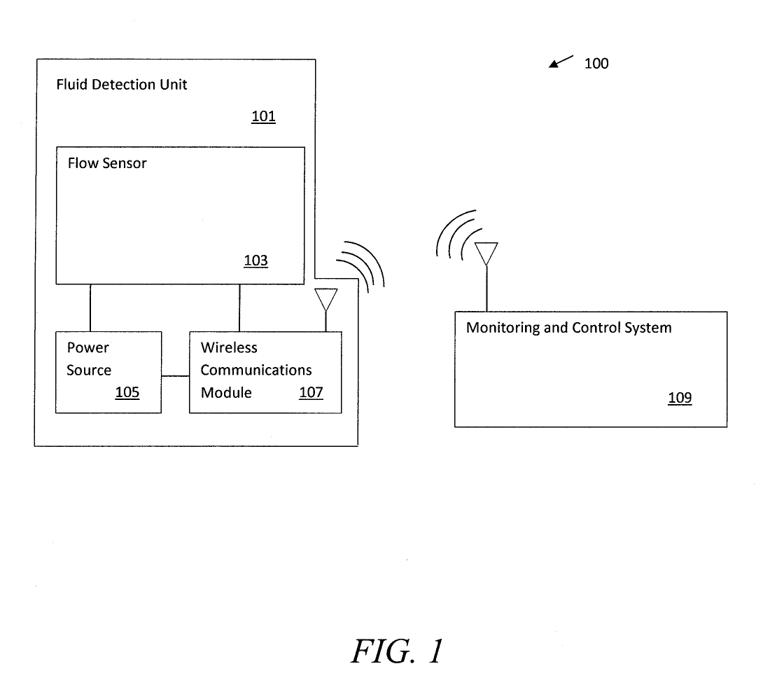

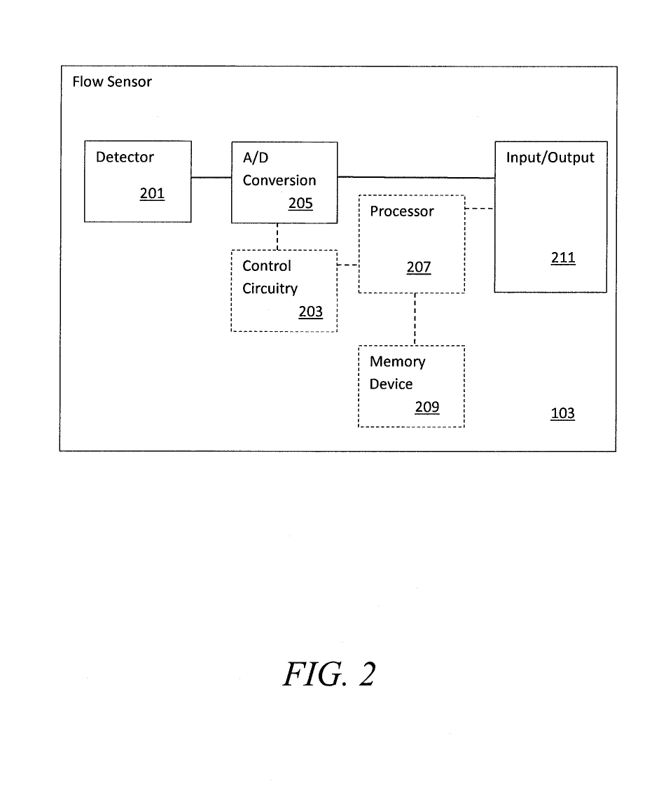

The various embodiments described herein are directed to a fluid control systems and methods used therewith. With regard to FIGS. 1-2, a fluid control system 100 and method for operating the system will be described. In reference to the embodiments discussed herein a fluid control system is described in use with water, however, the system need not be so restricted in this context. Any fluid that can be used in accordance with the system and method disclosed herein may be used. Such fluids may include, for example, beverage administration, chemicals used in batch processing for industrial operations, lubricants and cooling/heating substances used in motors or other devices, or other applications that require automatically filling or topping off of a container, reservoir, or storage tank from a source using a liquid. In addition, where applications are similarly situated, the fluid control system also may be used with a gas.

As shown in FIG. 1, in one embodiment a fluid control system 100 comprises a fluid detection unit 101 that includes a flow sensor 103 configured to measure a flow rate of a fluid or an in-rush fluid current through a pipe or conduit, a power source 105 coupled to the flow sensor 103, and a wireless communications module 107 coupled to the power source 105 and the flow sensor 103. In one embodiment, the fluid control system 100 is in communication with a monitoring and control system 109 that is remote from the fluid detection unit 101. In other embodiments, the fluid control system 100 comprises the monitoring and control system 109 that is remote from the fluid detection unit 101.

In one embodiment, the fluid detection unit 101, including the flow sensor 103, the power source 105, and the wireless communications module 107 may be manufactured as part of a conduit through which fluid flow is to be measured or monitored. The conduit may be sized and configured to be connected between a fluid source and a reservoir, such that the reservoir is located downstream of the fluid source. For instance, the fluid detection unit 101 may be manufactured integral with or as a component of a water supply tube for a residential or commercial toilet. Alternatively, the fluid detection unit 101 may be manufactured as a unitary apparatus, in which connectors are provided on either end of the fluid detection unit 101 to allow the sealed apparatus to be permanently or removably affixed inline with a fluid pipe. The fluid detection unit 101 also may be formed as a section of pipe or pipe fitting for various installations.

The power source 105 provides power to the components of the fluid detection unit 101, including the wireless communications module 107. The wireless communications module 107 may be, for example, a low power RF integrated circuit, so that the wireless communications module 107 is enabled to communicate with the monitoring and control system 109. In a preferred embodiment, the wireless communications module 107 is activated as water flows through the inlet of the fluid-flow measuring sensor 103. The activation may comprise the closure of a switch in a circuit that then allows power to be applied to the wireless communications module 107 from the power source 105. The fluid control system 100 may be configured such that activation of the wireless communications module 107 takes place only when the rate of flow (e.g., flow rate) of water through the flow sensor 103 meets at least a predetermined threshold. Accordingly, the activation of the wireless communications module 107 may take place only as enough power is generated by the power source 105 to energize the wireless communications module 107. In such an embodiment, energy from the power source 105 is conserved and activation of the wireless communications module 107 only takes place when appropriate.

In addition, the power source 105 may comprise an electrical connection, a battery, or an electrical power generation device, also called an energy harvester, or a combination of these. The power source 105 also may comprise any suitable components based on the location and application. For example, the power source 105 may provide electricity based on solar or wind power generation. In embodiments where the power source 105 is a generator, the power source 105 also may include a power storage device, such as a capacitor or battery, which stores excess electricity. In one embodiment, the power source comprises 105 an energy harvester that is configured to generate electrical energy derived from the fluid flow through the conduit. The use of a hydroelectric generation device allows the fluid control system to be used in locations where an electrical connection is unavailable, dispenses with the need to replace batteries, and provides power from the source that is most directly applicable to the implementation of the fluid control system 100.

As shown in FIG. 2, the flow sensor 103 may include a detector section 201, control circuitry 203, an analog to digital (“A/D”) conversion module 205, and an input/output section 211. The detector section 201 may comprise a sensor that detects flow of a fluid through the conduit based on the use of infrared, laser, magnetic frequency, or other similar techniques. The detector section 201 is coupled to the A/D conversion module 205 that allows a reading from the detector section 201 to be passed to other components. Based on the technology used to implement the detector section, the A/D conversion module 205 may not be necessary or may be part of the detector section 201. Additionally, the A/D conversion module 205 may be implemented as a circuit, which may include a software component. The input/output section allows information from the detector 201 to be provided to other components, including the wireless communication module 107 and the power source 105 described in connection with FIG. 1.

Alternatively, a processor 207 may be located within the flow sensor 103 and is electrically coupled to or otherwise connected to a memory device 209, or non-transitory computer readable medium, for recording data or information from the processor 207. Additionally, the processor 207 may be coupled to the control circuitry 203. The processor 207 and control circuitry 203 allow computational functions to be modified and carried out within the flow sensor 103 based on commands or instructions received from other components of the flow control system 100 shown in FIG. 1. Information that is the subject of the computational functions can then be stored in the memory device 209 for further processing or transmission to other components. As described further below, the processor 207 also may be located remotely from but in communication with the flow sensor 103.

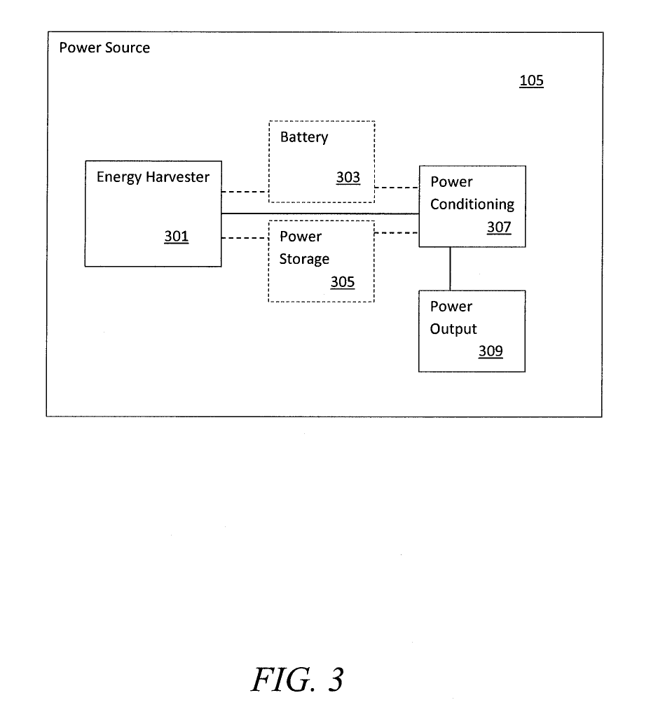

With reference to FIG. 3, the power source 105 of the fluid control system 100 includes at least one energy harvester 301. The energy harvester 301 is configured to generate electrical energy derived from the fluid flow, or gas flow in particular applications, through a conduit. The energy harvester 301 is connected to a power conditioning section 307 and then a power output section 309, which allows electricity to be provided to the other components of the fluid control system 100, including the wireless communications module 107, the flow sensor 103, as shown in FIGS. 1 and 2, and components thereof, as may be necessary. Also shown in FIG. 3, the power source 105 may alternatively include a battery 303 that allows additional power to be provided to components that are fed from the power source 105. Further, a power storage device 305 may included in the absence of or in addition to the battery, where the power storage device 305 is a capacitor, rechargeable battery, or other electricity storage element, among others. In other embodiments, the power source 105 may be a battery that is replaceable and/or rechargeable.

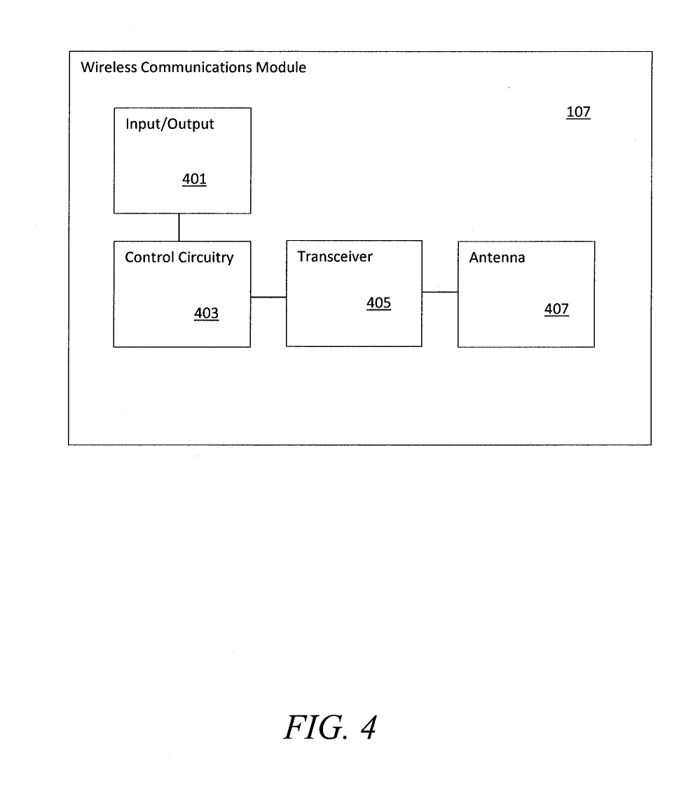

As shown in FIG. 4, the wireless communications module 107 comprises an input/output section 401, control circuitry 403, a transceiver 405, and an antenna 407. The wireless communications module 107 is designed and configured to be linked by a short range wireless communication connection that enables communication between the wireless communications module 107 and at least one other remote system or communications device. The control circuitry 403 and transceiver 405 enable the wireless communications module 107 to transmit and receive, to provide commands to other components and/or systems or to be commanded by components and/or systems, and to receive programming for the wireless communications module 107. The antenna 407 is operationally connected or coupled to the transceiver 405 and converts electric power into radio waves, and vice versa.

The wireless communications module 107 is configured to transmit information to and receive information from the remotely located monitoring and control system 109 as shown in FIG. 1. This may include, for example, transmitting information indicating a calculated volume of fluid that flowed through a section of pipe or conduit or receiving a configuration command that provides a predetermined volume for comparing the calculated volume. In a preferred embodiment, the wireless communications module 107 is a Wi-Fi embedded microchip and it may be located at least partially on an exterior of a conduit. In another preferred embodiment, the energy harvester 105 is configured to energize the wireless communications module 107 intermittently such that the wireless communications module 107 is not energized when the energy harvester is not generating electrical energy. As such, the wireless communications module 107 can be configured to transmit a wireless signal associated with a measured flow rate only when energized by the energy harvester 301 of the power source 105. By energizing the wireless communications module 107 only when the energy harvester 301 is generating electricity the fluid detection unit 101 or system 100, as shown in FIG. 1, may conserve energy and reduce or eliminate the need for additional energy storage devices such as a capacitor or battery. This may allow for a less expensive and/or a more compact design of the fluid detection unit 101, for example.

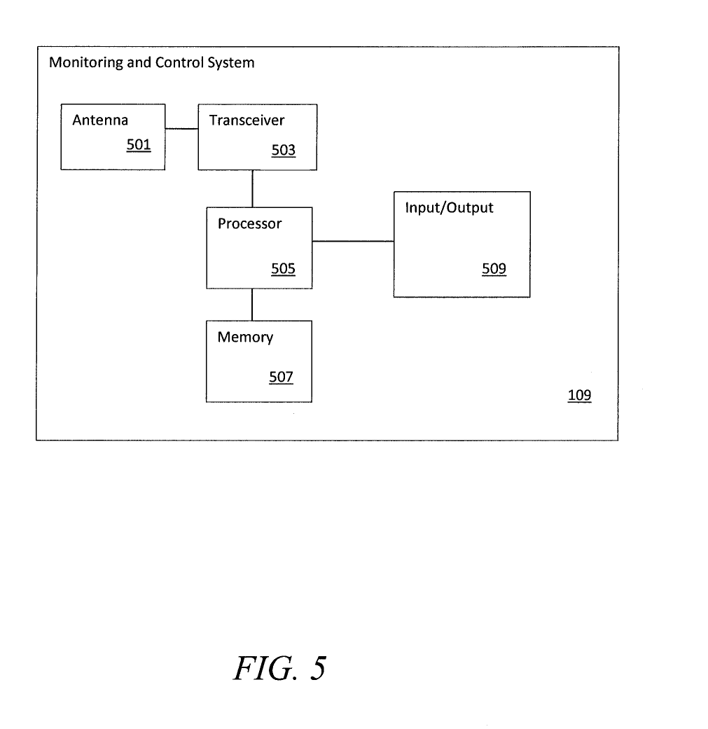

Additionally, a monitoring and control system 109, as shown in FIG. 5, comprises an antenna 501, a transceiver 503, a processor 505 and associated memory storage 507, and an input/output section 509. The components of the monitoring and control system 109 function the same or similar to those components similarly named and previously described. In one embodiment, the processor 505 portion of the monitoring and control system 109 is configured to receive a wireless signal through the antenna 501 and transceiver 503 of the monitoring and control system 109. The wireless signal may be associated with a flow rate of a fluid through a conduit in which the flow sensor 103 (FIGS. 1 and 2) and energy harvester 301 (FIG. 3) are located. The wireless signal may include readings of a flow rate taken by the flow sensor 103 that are transmitted from the wireless communications module 107, which is in communication with the flow sensor 103. According to the information contained in the wireless signal, the processor 505 of the monitoring and control system 109 is configured to calculate a volume of fluid and compare the calculated volume to a predetermined volume. When the calculated volume is less than the predetermined volume, the processor 505 is configured to record the calculated volume in the memory storage 507.

The processor 505 of the monitoring and control system 109 also is configured to determine a control number, which is defined as a number of times that the calculated volume is determined to be less than the predetermined volume for a defined time period. The processor 505 is configured to employ the control number and compare it to a predetermined alarm condition. When the processor 505 determines that the control number is greater than a predetermined alarm condition, the monitoring and control system 109 is configured to enter into an alarm state. The predetermined alarm condition may be a simple logic statement regarding a number of times that the calculated volume of fluid is less than a predetermined volume. As such, in the event that the control number is greater than what the predetermined alarm condition is set at, the processor 505 is configured to cause an alert to be provided to a user. The alert may be communicated in such a way that the user would understand that the tank to which the conduit is connected has a leak. In one embodiment, the predetermined volume is based on a capacity of fluid held by a residential or commercial water heater tank or a residential or commercial toilet tank. In other embodiments, the predetermined volume is based on a predetermined amount of water or other fluid flowing through or to, for example, a spigot, faucet, showerhead, bathtub spout, sprinkler system, laundry machine, water storage systems, fluid based heating systems, drainage systems, sewer systems, hydrant systems, beverage dispensing or filling systems, chemical storage or dispensing facilities, as a non-exhaustive list. Moreover, embodiments of the present disclosure may be applied in any appropriate system that uses a fluid or gas.

With reference to FIGS. 1 and 5, in another embodiment, the monitoring and control system 109 further comprises a control panel (not shown) and when the monitoring and control system 109 goes into an alarm state, the control panel is configured to display a local alert. The local alert displayed by the control panel may comprise information regarding a zone of a structure in which the fluid detection unit is located. For example, in the event that multiple fluid detection units 101 are employed in a housing structure, such as with an apartment complex that contains multiple water storage tanks, the local alert may provide a floor and room number where the fluid detection unit 101 is located.

As previously discussed in connection with FIG. 2, in one embodiment, the processor 207 may be included as a component of the flow sensor 103 and is electrically coupled to or otherwise connected to a memory storage device 209 for recording data or information from the processor 207. In such an embodiment, the processor 207 of the flow sensor 103 may perform the same or substantially the same functions as the processor 505 (FIG. 5) of the previously referred monitoring and control system 109 to replace those functions and perform them locally at the flow sensor 103.

For example, the processor 207 may be coupled to the flow sensor 103 and the energy harvester 301 may be configured to energize the processor 207. The processor 207 is configured to monitor the measured flow rate over a period of time and calculate a volume of the fluid that passed through a conduit over the period of time. Further, the processor 207 is configured to compare the calculated volume with a predetermined volume. A memory storage device 209, or non-transitory computer readable medium, is coupled to the processor 207 such that when the calculated volume is less than the predetermined volume, the processor 207 records or stores the calculated volume in the non-transitory computer readable medium 209. Additionally, the processor 207 is enabled to determine a control number, which defines a number of times that the calculated volume is less than the predetermined volume, and if the control number is greater than a predetermined alarm condition based on a comparison the two, the processor 207 causes the wireless communications module 107 to transmit a wireless signal associated with the predetermined alarm condition. The wireless signal may then be received by the monitoring and control system 109 and appropriate alert may be displayed to a user.

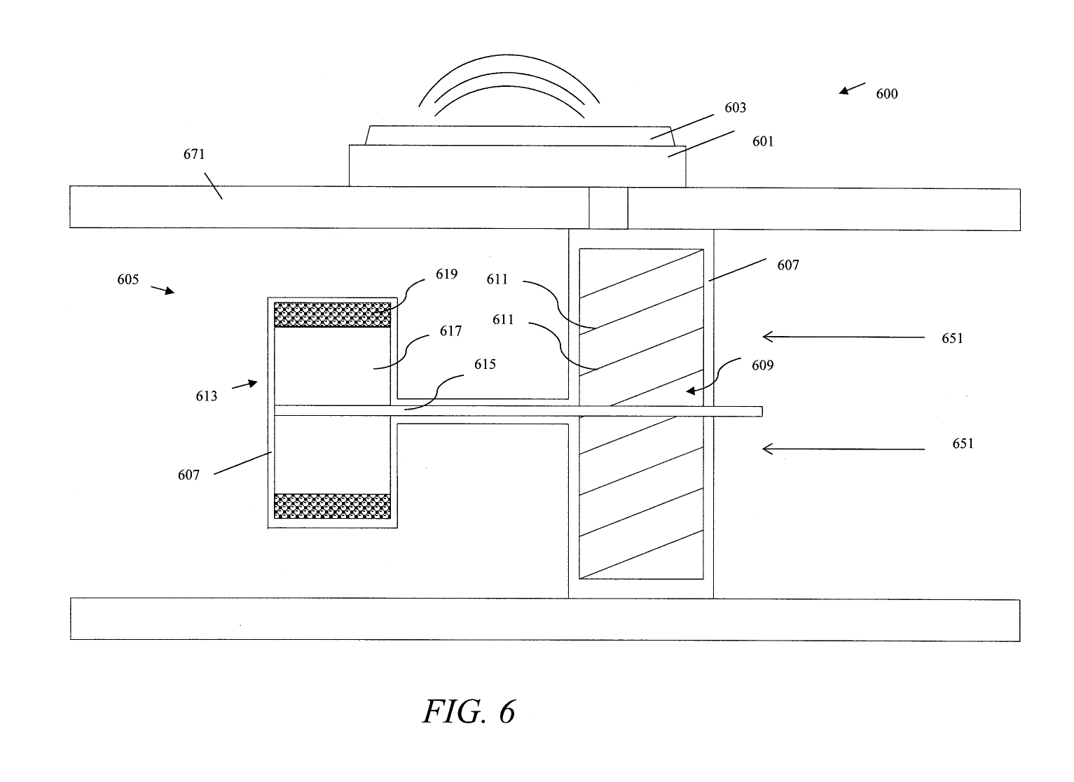

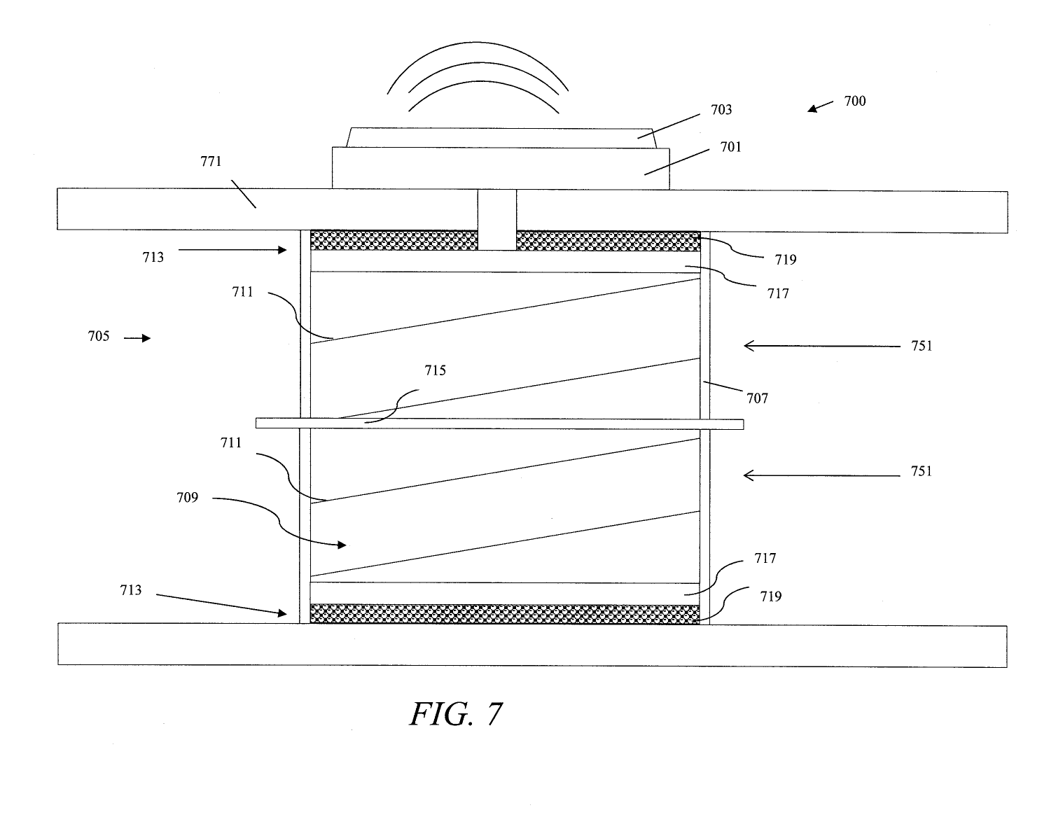

FIGS. 6 and 7 show one embodiments of the fluid detection unit 101 discussed in connection with FIG. 1. As described in connection with FIGS. 6 and 7, an energy harvester may incorporate a hydroelectric turbine design as a generator. The energy harvester may generate electricity based on the rotational movement of a turbine where a generator is connected to or integrated with the turbine's rotational element. In the embodiments shown in FIGS. 6 and 7, the rotation of the generator is aligned in a direction that is parallel to the flow direction of liquid in the pipe, however, the generator may also be aligned in a direction that is perpendicular to the flow direction of the liquid and also may comprise multiple rotational elements.

As shown in FIG. 6, the fluid detection unit 600 comprises a flow sensor 601, a wireless communication module 603, and an energy harvester 605. According to FIG. 6, the flow sensor 601, wireless communication module 603, and energy harvester 605 are configured as part of a conduit 671. The arrows 651 indicate the direction of fluid flow through the conduit. Components of the energy harvester 605 and flow sensor 601 are encased in a housing 607 and are protected from the fluid flow. The energy harvester 605 comprises a rotary element 609 that has a plurality of vanes 611 to harness the force of the fluid flow. The generator section 613 of the energy harvester 605 is connected to the rotary element via the shaft 615. The generator section 613 comprises a rotor 617 having a plurality of magnets that spin within the coils of a stator 619 to generate electricity.

Similar to FIG. 6, FIG. 7 illustrates an alternative design of the fluid detection unit 700. The fluid detection unit 700 comprises of a flow sensor 701, a wireless communication module 703, and an energy harvester 705. The flow sensor 701, wireless communication module 703, and energy harvester 705 are configured as part of a conduit 771. The arrows 751 indicate the direction of fluid flow through the conduit 771 and components of the energy harvester 705 and flow sensor 701 are within a housing 707. The energy harvester 705 comprises a rotary element 709 that has a plurality of vanes 711 to harness the force of the fluid flow. The generator section 713 of the energy harvester 705 is incorporated with the rotary element 709 such that the rotor 717 comprises a plurality of magnets located at the circumference of the rotary element 709. As the rotary element 709 spins, the rotor 617 is turned within the coils of a stator 619 to generate electricity.

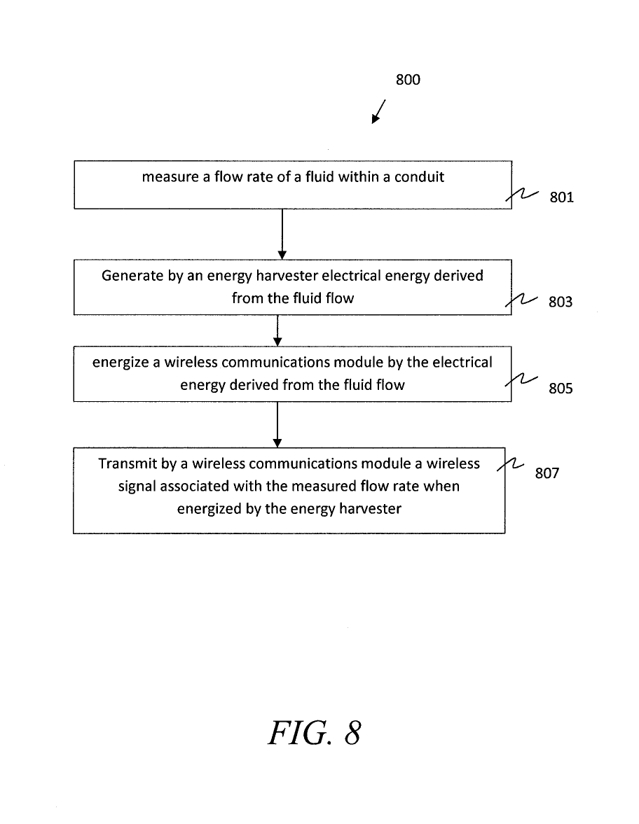

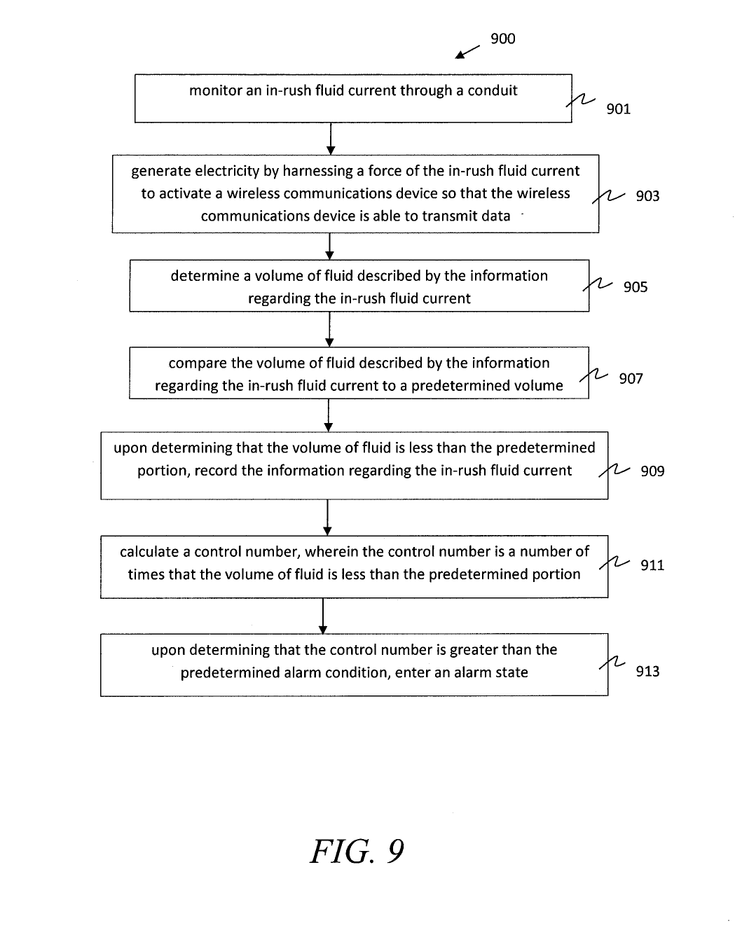

Methods for determining fluid volume in a system are shown in and described with regard to FIGS. 8 and 9. The methods or processes described in FIGS. 8 and 9 may be performed by hardware or software incorporated in the fluid detection unit 101 or flow sensor 103 shown in FIGS. 1 and 2. When the process is performed by software, the software may reside in software memory (not shown) in the fluid detection unit 101 or the monitoring and control system 109. The software stored in the software memory may include an ordered listing of executable instructions for implementing logical functions (i.e., “logic” that may be implement either in digital form such as digital circuitry or source code or in analog form such as analog circuitry or an analog source such an analog electrical, sound or video signal), may selectively be embodied in any computer-readable (or signal-bearing) medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “computer-readable medium” and/or “signal-bearing medium” is any means that may contain, store, communicate, propagate, or transport the program for use by or in connection with the instruction execution system, apparatus, or device. The computer readable medium may selectively be, for example but not limited to, an electronic, magnetic, optical, electromagnetic, infrared, or semiconductor system, apparatus, device, or propagation medium. More specific examples “a non-exhaustive list” of the computer-readable medium would include the following: an electrical connection “electronic” having one or more wires, a portable computer diskette (magnetic), a RAM (electronic), a read-only memory “ROM” (electronic), an erasable programmable read-only memory (EPROM or Flash memory) (electronic), an optical fiber (optical), and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

FIG. 8, with reference also to FIGS. 1-4, shows one embodiment of a method 800 for determining fluid volume in a system comprises a processor 207 configured to measure 801 a flow rate of a fluid within a conduit, then generate 803, by an energy harvester 301, electrical energy derived from the fluid flow, energize 805 a wireless communications module 107 with the electrical energy derived from the fluid flow, and transmit 807, by the wireless communications module 107, a wireless signal associated with the measured flow rate when energized. Further, the wireless communications module 107 is configured to transmit the wireless signal when energized by the energy harvester 301.

FIG. 9, and with reference also to FIGS. 1-4, shows another embodiment of a method 900 for determining fluid volume in a system. According to the method 900, a flow sensor 103 is configured to monitor 901 an in-rush fluid current through a conduit, an energy harvester 301 is configured to generate 903 electricity by harnessing a force of the in-rush fluid current to activate a wireless communications module 107 so that the wireless communications module 107 is able to transmit data, a processor 207 is configured to determine 905 a volume of fluid described by the information regarding the in-rush fluid current, and the processor 207 is configured to compare 907 the volume of fluid described by the information regarding the in-rush fluid current to a predetermined volume. The method 900 also comprises a processor 207 configured to determine 909 when the volume of fluid is less than a predetermined portion of the predetermined volume and upon determining that the volume of fluid is less than the predetermined portion, recording the information regarding the in-rush fluid current, to calculate 911 a control number, which is a number of times that the volume of fluid is less than the predetermined portion, and to determine when the control number is greater than a predetermined alarm condition. Upon determining that the control number is greater than the predetermined alarm condition, the monitoring and control system 109 is configured to enter 913 an alarm state. Additional functional aspects of the method 900 described may be performed according to embodiments discussed throughout this disclosure.

Furthermore, an algorithm may be developed that allows a user to establish an appropriate level of water use for each installation of the fluid control system. In one embodiment, the algorithm may be implemented with the control circuitry 203 and processor 207 of the flow sensor 103. In such an embodiment, the flow sensor 103 determines when an inappropriate amount of water is following through an installation and communicates an alert to the monitoring and control system 109 via the wireless communications module 107. The monitoring and control system 109 may comprise an application on a smartphone that allows a user to manage the installations and determine precisely which installation of a number of installations is showing a problem.

In another embodiment, the algorithm may be implemented by the monitoring and control system 109. In such an embodiment, the flow sensor 103 determines an amount of water flowing through an installation and to transmit this information to the monitoring and control system 109 via the wireless communications module 107. A form of location indication may also be provided with the transmission. The monitoring and control system 109 would then be able to determine precisely which installation of a number of installations is experiencing a problem.

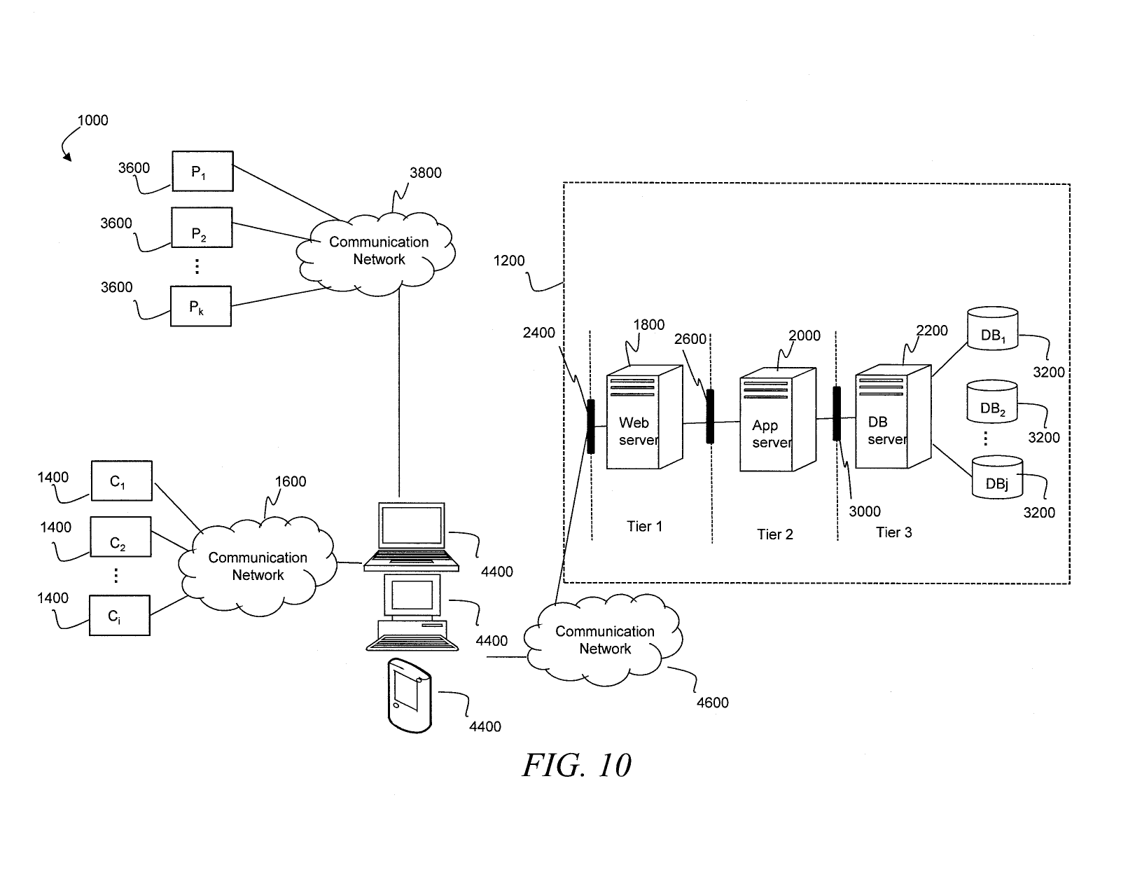

FIG. 10 illustrates a network architecture and computing environment for an embodiment of a fluid control system. FIG. 10 illustrates a system 1000 according to embodiments of the present disclosure. As shown in FIG. 10, the system 1000 includes one or more client devices C₁, C₂, . . . , Cᵢ 1400 (hereinafter referred to as “clients 1400”) in communication with one or more remote computing devices 4400 via a communications network 1600 and the computing devices 4400 are in communication with a host system 1200 via a communications network 4600. In embodiments, additional clients P₁, P₂, . . . , Pₖ 3600 (hereinafter referred to as “clients 3600”) are in communication with the computing devices 4400 via a communications network 3800. The communication networks 1600, 3800, and 4600 may be a common communication network (e.g., the Internet). In certain embodiments, the host system 1200 and/or the computing devices 4400 may implement some or all of the aspects of the monitoring and control system described herein, respectively, and the clients 1400, 3600 may implement some or all of the aspects of the fluid detection unit described herein.

While the communications networks 1600, 3800, and 4600 may be the Internet, it will be appreciated that any public or private communication network, using wired or wireless channels, suitable for enabling the electronic exchange of information between the clients 1400, clients 3600, the computing devices 4400, and the host system 1200 may be utilized. The one or more of the communications networks 1600, 3800 and 4600 can be any network or combination of networks that can carry data communications. Such networks can include, but are not limited to, wireless data networks such as a Wi-Fi, 3G, and a 4G/LTE network. In addition, the communications networks 1600, 3800, and 4600 shown in FIG. 10 can include, but are not limited to a wired Ethernet network, a local area network (LAN), a medium area network, and/or a wide area network (WAN) such as the Internet. In various implementations of system 1000 including wireless networks, one or more of the communications networks 1600, 3800 and 4600 can support protocols and technology including, but not limited to, Internet or World Wide Web protocols and/or services. Intermediate network routers, gateways, or servers (not shown) may be provided between components of the system 1000 depending upon a particular application or environment.

According to various embodiments, the host system 1200 may be implemented by an institution, (hereinafter referred to as a ‘host institution’) such as for example, a management institution that manages properties where a fluid control system is implemented. In additional embodiments, the functional aspects of the computing devices 4400 can be included within the host system 1200, and the clients 1400, 3600 communicate with, provide information to, and receive commands from the host system 1200, directly.

In preferred embodiments, the clients 1400, 3600 may include any form of network-enabled communications module configured to transmit and receive information via the communications network 1600, 3800 using a wired or wireless connection. Clients 1400, 3600 are capable of receiving user input from the computing devices 4400 via the communications network 1600, 3800. In various embodiments, a computing device 4400 can be, but is not limited to, a personal computer (PC), may be PCs and/or other network-enabled devices (e.g., cell phones, mobile phones, mobile tablets, PDAs, etc.) configured to transmit and receive information via the communication networks 1600, 3800, 4600 using a wired or wireless connection. Furthermore, the computing devices 4400 may be an iPhone™, an iPod™, an iPad™, a device operating the Android operating system (“OS”) from Google Inc., a device running the Microsoft Windows® Mobile OS, a device running the Microsoft Windows® Phone OS, a device running the Symbian OS, a device running the webOS from Hewlett Packard, Inc., a mobile phone, a BlackBerry® device, a smartphone, a hand held computer, a netbook computer, a palmtop computer, a laptop computer, an ultra-mobile PC, a portable gaming system, or another similar type of mobile computing device having a capability to communicate with clients 1400, 3600 and the host system 1200 via the communications network 1600, 3800, 4600. The computing devices 4400 may include a suitable browser software application (e.g., Internet Explorer, Internet Explorer Mobile, Chrome, Safari, Firefox, Blazer, etc.) for enabling the user to display and interact with information exchanged via the communication networks 1600, 3800, 4600.

According to embodiments, an input device of the computing device 4400 may be one or more of a touch-sensitive display such as a touch screen interface, a keyboard, a microphone, or a pointing device such as a mouse or stylus. The computing device 4400 also include a display device capable of rendering an interactive Graphical User Interface (“GUI”) for providing commands to the clients 1400, 3600. The input device allows a user to interact with the GUI to instruct the clients 1400, and to display and edit information, which is rendered in the display device. The computing devices 4400 may thus access and navigate static and/or dynamic HTML documents of the GUI. Alternatively, the GUI can be rendered on a display device of one or more servers, such as a web server 1800, application server 2000, and database server 2200 shown in FIG. 10.

A display device of the computing device 4400 can differ depending on the application of the fluid control system. For example, a display device of a tablet device, netbook, or laptop is typically an integrated LCD screen, which is often smaller than a monitor or console such as the display device for a workstation or desktop PC. Similarly, the display device of a mobile computing device may be a relatively small display such as mobile phone display.

The input devices can also vary depending on the characteristics of a particular computing device 4400 and its display device. For example, the input device of a tablet, netbook, or laptop may include a relatively small physical or touchscreen keyboard, an integrated camera, track pad, and/or microphone, while the input device of a desktop PC or workstation client will typically include a physical QWERTY or Dvorak keyboard and a mouse. Also, for example, an input device of a mobile device will typically lack a full physical keyboard and may instead comprise one or more of a touch-screen keyboard, a microphone, an integrated camera, a track pad, a scroll wheel, a track ball, a T9 keyboard, a button, and a touch screen display device. In embodiments, a display device can be a touch screen display. It is to be understood that in the case of a touch screen interface, the input device can be anything capable of interacting with the touch screen, including a user's fingers, which can be used to select, slide, drag, and resize (i.e., expand, maximize, shrink, and/or minimize) interactive user interface (“UI”) elements through pointing, pinching, and scrolling gestures.

According to embodiments, UIs for mobile computing devices may be rendered as streamlined ‘mobile friendly’ versions of the ‘full’ UI for ease of use on relatively small display devices. In embodiments, mobile friendly UIs may have reduced capabilities and/or display a lesser level of detail as compared to full UI. A mobile friendly UI can also be tailored to accept input from input devices for a specific platform of a mobile computing device. Mobile friendly UIs can be automatically selected by the system 1000 in response to detecting one or more platform characteristics of a particular mobile computing device. Alternatively, a user of a mobile computing device can be prompted within the full UI to opt-in to using the mobile friendly UIs in response to detecting that the computing device is accessing the host system 1200 via a mobile computing device. In cases where a user's mobile computing device has display devices and input devices capable of using the full UI, the user may not wish to use the mobile friendly UI.

In accordance with embodiments, the UI can be tailored to or customized for a particular computing device 4400 based on the capabilities of the platform used by that computing device. The platform comprises physical capabilities of the computing device such as, memory capacity in terms of random access memory (RAM) and read only memory (ROM), central processing unit (CPU) capabilities in terms of clock speed and available processing capacity, available storage in terms of disk space or flash memory, communications capabilities in terms of current wired and/or wireless network connectivity and a communications interface such as a network interface card (“NIC”) of the computing device, capabilities of the display device, and capabilities of the input device. These physical capabilities and others can be determined based on a manufacturer, model number, serial number, a Media Access Control address (“MAC address”) and/or another unique identifier of a computing device 4400.

The platform of a computing device 4400 also comprises software and firmware components, such as an operating system (“OS”) running on the computing device 4400, Internet browser(s), native software applications installed, and privileges/permissions associated with the computing device. The privileges/permissions may be controlled by the host system 1200 based on a user and/or an entity associated with the computing device and can include data access, communications, and application execution privileges.

In the embodiment depicted in FIG. 10, the host system 1200 can be based on a multi-tiered network architecture, and can include one or more of a web server 1800 (Tier 1), an application server 2000 (Tier 2), and a database server 2200 (Tier 3). According to this embodiment, the web server 1800 corresponds to the first tier of the host system 1200 and is configured to communicate with the communication network 4600 via a border firewall 2400, and with the application server 2000 via an application firewall 2600. The web server 1800 can be configured to accept information requests, such as, for example, HTTP requests, from one or more of the computing devices 4400 via the communication network 4600 and to provide responses thereto. The responses may include, for example, HTTP responses including static and/or dynamic HTML documents for providing a GUI to users via the computing devices 4400. Additionally, the web server 1800 may further be configured to authenticate each user before allowing access to a GUI and other resources associated with the host system 1200. Authentication may be performed, for example, by validating a received account identifier (“ID”) or user name and a corresponding password. The ID/user name and password may be input in the GUI using an input device of the computing device 4400.

With continued reference to the embodiment of FIG. 10, the application server 2000 corresponds to the second tier of the host system 1200 and can be configured to communicate with the web server 1800 via the application firewall 2600, and with the database server 2200 via an internal firewall 3000. The application server 2000 may host one or more applications executing logic to provide features to each user of the fluid control system via a respective user interface (“UI”). The application server 3000 may receive account credentials (e.g., an account ID/user name and password), input and selections (e.g., a request to access data management features) from the UI associated with each client 1400, 3600 via the web server 1800. Based on this and other information received from the clients 1400, 3600 applications hosted by the application server 2000 may be invoked to perform various calculations or data manipulation functions and generate corresponding informational content. Informational content may be communicated to the web server 1800 and subsequently presented to a user associated with computing device 4400 using, for example, a dynamic web page or interactive GUI. Additionally, the application server 2000 may also host an application for enabling users to conduct email communication with the parties associated with the host system 1200 and other parties, for example maintenance contractors based on alerts or other informational content associated with the system 1000.

In the embodiment shown in FIG. 10, the database server 2200 corresponds to the third tier of the host system 1200 and is configured to communicate with the application server 2000 via the internal firewall 3000. The database server 2200 manages one or more databases DB₁, DB₂, . . . , DBᵢ 3200 (hereinafter referred to as “databases 3200”) which store data to support one or more applications hosted by the application server 2000 or elsewhere. Such databases may include, for example, stored information databases, client configuration databases, user reporting databases, user identification/authentication databases, user preferences/settings databases, as well as databases for storing other settings and/or configuration data. Database information requested by a particular application is retrieved from the databases 3200 by the database server 2200, communicated to the requesting application, and updated by the database server 2200 as needed. Additionally, although only a web server 1800, application server 2000, and database server 2200 are depicted in FIG. 10, it is to be understood that in certain embodiments, the functionalities of one or more of these servers can be implemented cluster of computing devices operating in a cluster or server farm.

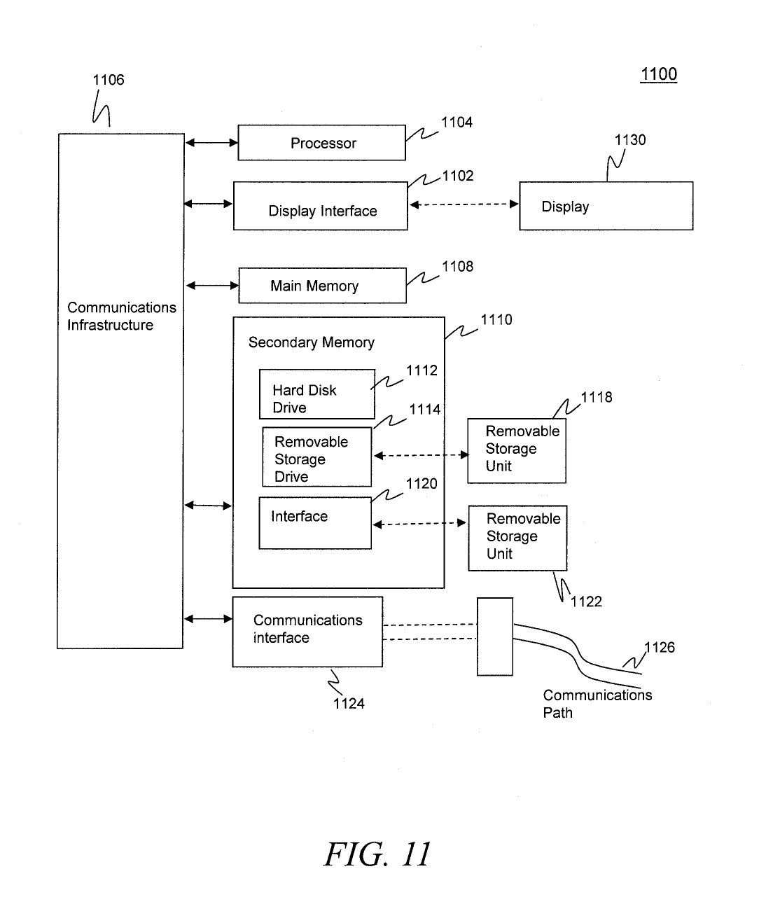

As would be appreciated by someone skilled in the relevant art(s) and described below with reference to FIG. 11, part or all of one or more aspects of the methods and system discussed herein may be distributed as an article of manufacture that itself comprises a computer readable medium having computer readable code means embodied thereon.

The computer readable program code means is operable, in conjunction with a computer system, to carry out all or some of the steps to perform the methods or create the system discussed herein. The computer readable medium may be a recordable medium (e.g., hard drives, compact disks, EPROMs, or memory cards). Any tangible medium known or developed that can store information suitable for use with a computer system may be used. The computer-readable code means is any mechanism for allowing a computer to read instructions and data, such as magnetic variations on a magnetic media or optical characteristic variations on the surface of a compact disk. The medium can be distributed on multiple physical devices (or over multiple networks). For example, one device could be a physical memory media associated with a terminal and another device could be a physical memory media associated with a processing center.

The computer devices, systems, and servers described herein each contain a memory that will configure associated processors to implement the methods, steps, and functions disclosed herein. Such methods, steps, and functions can be carried out, e.g., by processing capability on mobile device, POS terminal, payment processor, acquirer, issuer, or by any combination of the foregoing. The memories could be distributed or local and the processors could be distributed or singular. The memories could be implemented as an electrical, magnetic or optical memory, or any combination of these or other types of storage devices. Moreover, the terms “memory”, “memory storage”, “memory device”, or similar terms should be construed broadly enough to encompass any information able to be read from or written to an address in the addressable space accessed by an associated processor.

Aspects of the present disclosure discussed with regards to and shown in FIGS. 1-9, or any part(s) or function(s) thereof as appropriate, may be implemented using hardware, software modules, firmware, tangible computer readable media having instructions stored thereon, or a combination thereof and may be implemented in one or more computer systems or other processing systems.

FIG. 11 illustrates an example computer system 1100 in which embodiments of the present disclosure, or portions thereof, may be implemented as computer-readable code. For example, the various aspects of the user interface can be implemented in computer system 1100 using hardware, software, firmware, non-transitory computer readable media having instructions stored thereon, or a combination thereof and may be implemented in one or more computer systems or other processing systems. Hardware, software, or any combination of such may embody any of the modules and components used to implement the network, systems, methods and GUI described above. For example, some or all of the aspects, as appropriate, of the computing devices 4400, web server 1800, application server 2000, and/or database server 2200 described above with reference to FIG. 10 can be implemented using computer system 1100.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments. A processor device may be a single processor, a plurality of processors, or combinations thereof. Processor devices may have one or more processor “cores.”

Various embodiments of the present disclosure are described in terms of this example computer system 1100. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

The processor device 1104 may be a special purpose or a general purpose processor device. As will be appreciated by persons skilled in the relevant art, processor device 1104 may also be a single processor in a multi-core/multiprocessor system, such system operating alone, or in a cluster of computing devices operating in a cluster or server farm. Processor device 1104 is connected to a communication infrastructure 1106, for example, a bus, message queue, network, or multi-core message-passing scheme.

The computer system 1100 also includes a main memory 1108, for example, random access memory (RAM), and may also include a secondary memory 1110. Secondary memory 1110 may include, for example, a hard disk drive 1112, removable storage drive 1114. Removable storage drive 1114 may comprise a floppy disk drive, a magnetic tape drive, an optical disk drive, a flash memory, or the like.

The removable storage drive 1114 may read from and/or writes to a removable storage unit 1118 in a well-known manner. The removable storage unit 1118 may comprise a floppy disk, magnetic tape, optical disk, Universal Serial Bus (“USB”) drive, flash drive, memory stick, etc. which is read by and written to by removable storage drive 1114. As will be appreciated by persons skilled in the relevant art, the removable storage unit 1118 includes a non-transitory computer usable storage medium having stored therein computer software and/or data.

In alternative implementations, the secondary memory 1110 may include other similar means for allowing computer programs or other instructions to be loaded into computer system 1100. Such means may include, for example, a removable storage unit 1122 and an interface 1120. Examples of such means may include a program cartridge and cartridge interface (such as that found in video game devices), a removable memory chip (such as an EPROM, or PROM) and associated socket, and other removable storage units 1122 and interfaces 1120 which allow software and data to be transferred from the removable storage unit 1122 to computer system 1100.

The computer system 1100 may also include a communications interface 1124. The communications interface 1124 allows software and data to be transferred between the computer system 1100 and external devices. The communications interface 1124 may include a modem, a network interface (such as an Ethernet card), a communications port, a PCMCIA slot and card, or the like. Software and data transferred via the communications interface 1124 may be in the form of signals, which may be electronic, electromagnetic, optical, or other signals capable of being received by communications interface 1124. These signals may be provided to the communications interface 1124 via a communications path 1126. The communications path 1126 carries signals and may be implemented using wire or cable, fiber optics, a phone line, a cellular/wireless phone link, an RF link or other communications channels.

In this document, the terms ‘computer readable storage medium,’ ‘computer program medium,’ ‘non-transitory computer readable medium,’ and ‘computer usable medium’ are used to generally refer to tangible and non-transitory media such as removable storage unit 1118, removable storage unit 1122, and a hard disk installed in hard disk drive 1112. Signals carried over the communications path 1126 can also embody the logic described herein. The computer readable storage medium, computer program medium, non-transitory computer readable medium, and computer usable medium can also refer to memories, such as main memory 1108 and secondary memory 1110, which can be memory semiconductors (e.g. DRAMs, etc.). These computer program products are means for providing software to computer system 1100. Computer programs (also called computer control logic and software) are generally stored in a main memory 1108 and/or secondary memory 1110. The computer programs may also be received via a communications interface 1124. Such computer programs, when executed, enable computer system 1100 to become a specific purpose computer able to implement the present disclosure as discussed herein. In particular, the computer programs, when executed, enable the processor device 1104 to implement the processes of the present disclosure discussed below. Accordingly, such computer programs represent controllers of the computer system 1100. Where the present disclosure is implemented using software, the software may be stored in a computer program product and loaded into the computer system 1300 using the removable storage drive 1114, interface 1120, and hard disk drive 1112, or communications interface 1124.

Although the various embodiments of the devices have been described herein in connection with certain disclosed embodiments, many modifications and variations to those embodiments may be implemented. For example, different types of end effectors may be employed. Also, where materials are disclosed for certain components, other materials may be used. The foregoing description and following claims are intended to cover all such modification and variations.

Any patent, publication, or other disclosure material, in whole or in part, said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, said to be incorporated by reference herein, but which conflicts with existing definitions, statements, or other disclosure material set forth herein will only be incorporated to the extent that no conflict arises between that incorporated material and the existing disclosure material.

1. A fluid-flow detection system comprising:
a flow sensor configured to measure a flow rate of a fluid within a conduit;
an energy harvester coupled to the flow sensor, the energy harvester configured to generate electrical energy derived from the fluid flow; and
a wireless communications module coupled to the energy harvester, the wireless communications module configured to transmit a wireless signal associated with the measured flow rate; and
wherein the wireless communications module transmits the wireless signal when energized by the energy harvester.

2. The system of claim 1, further comprising a processor coupled to the flow sensor and the energy harvester, the processor configured to monitor the measured flow rate over a period of time and calculate a volume of the fluid that passed through the conduit over the period of time, the processor further configured to compare the calculated volume with a predetermined volume.

3. The system of claim 2, wherein the wireless communications module is configured to transmit a wireless signal associated with the calculated volume.

4. The system of claim 2, further comprising a non-transitory computer readable medium coupled to the processor and wherein if the calculated volume is less than the predetermined volume, the processor records the calculated volume in the non-transitory computer readable medium.

5-6. (canceled)

7. The system of claim 1, wherein the energy harvester is configured to energize the wireless communications module intermittently such that the wireless communications module is not energized when the energy harvester is not generating electrical energy for the wireless communications module.

8. The system of claim 2, wherein the energy harvester is configured to energize the processor.

9. The system of claim 1, wherein the flow sensor is configured to monitor an in-rush fluid current through the conduit.

10. (canceled)

11. The system of claim 1, wherein the flow sensor, the energy harvester, and the wireless communications module are manufactured as part of the conduit.

12. (canceled)

13. The system of claim 1, wherein the energy harvester comprises a hydroelectric turbine.

14. The system of claim 1, wherein the wireless communications module is a Wi-Fi embedded microchip.

15. (canceled)

16. The system of claim 1, further comprising a battery coupled to the wireless communications module.

17-22. (canceled)

23. A method for determining fluid volume in a system comprising:
measuring, by a flow sensor, a flow rate of a fluid within a conduit;
generating, by an energy harvester, electrical energy derived from the fluid flow;
energizing, by the energy harvester, a wireless communications module the electrical energy derived from the fluid flow;
transmitting, by a wireless communications module, a wireless signal associated with the measured flow rate when energized; and
wherein the wireless communications module is configured to transmit the wireless signal when energized by the energy harvester.

24. The method of claim 23, further comprising:
monitoring, by a processor, the measured flow rate over a period of time;
calculating, by the processor, a volume of the fluid that passed through the conduit over the period of time; and
comparing, by the processor, the calculated volume with a predetermined volume; and
transmitting, by a wireless communication module, a wireless signal associated with the calculated volume.

25. The method of claim 24, further comprising upon determining, by the processor, that the calculated volume is less than the predetermined volume, recording, by the processor, the calculated volume in a non-transitory computer readable medium.

26-28. (canceled)

29. The method of claim 23, further comprising energizing a processor, by the energy harvester, wherein the processor is configured to calculate a volume of the fluid that passed through the conduit over a period of time and is configured to compare the calculated volume with a predetermined volume.

30. The method of claim 23, further comprising monitoring, by the flow sensor, an in-rush fluid current through the conduit.

31. (canceled)

32. A method for determining fluid volume in a system comprising:
monitoring, by a flow sensor, an in-rush fluid current through a conduit;
generating electricity, by an energy harvester, by harnessing a force of the in-rush fluid current to activate a wireless communications device so that the wireless communications device is able to transmit data;
determining, by a processor, a volume of fluid described by the information regarding the in-rush fluid current;
comparing, by the processor, the volume of fluid described by the information regarding the in-rush fluid current to a predetermined volume; and
determining, by the processor, when the volume of fluid is less than a predetermined portion of the predetermined volume;
upon determining, by the processor, that the volume of fluid is less than the predetermined portion, recording the information regarding the in-rush fluid current; and
calculating, by the processor, a control number, wherein the control number is a number of times that the volume of fluid is less than the predetermined portion;
determining, by the processor, when the control number is greater than a predetermined alarm condition; and
upon determining, by the processor, that the control number is greater than the predetermined alarm condition, entering an alarm state.

33. The method of claim 32, further comprising transmitting, by a wireless communications module, a wireless signal associated with the alarm state.

34. The method of claim 33, wherein the electricity is generated by an energy harvester, the method further comprising intermittently energizing, the energy harvester, the wireless communications module such that the wireless communications module is not energized when the energy harvester is not generating electrical energy for the wireless communications module.

35. (canceled)

36. The method of claim 33, further comprising transmitting, by the wireless communications module, information regarding the in-rush fluid current to a remote monitoring and control system.
